(19) United States
(12) Patent Application Publication
(10) Pub. No.: US 2009/0089212 A1
(43) Pub. Date: Apr. 2, 2009

(54) INFORMATION PROCESSING APPARATUS AND CONTENT LIST DISPLAY METHOD

(75) Inventor: Toshihiro MOROHOSHI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/196,712

(22) Filed: Aug. 22, 2008

(30) Foreign Application Priority Data
Sep. 28, 2007 (JP) 2007-256241

(51) Int. Cl. H04L 9/00

(52) U.S. Cl. 705/59

(57) ABSTRACT

According to one embodiment, an information processing apparatus comprises a communication module configured to communicate through a network with a content server which provides contents and a license server which manages license information of the contents provided by the content server, an inquiry module configured to inquire of the license server permission to acquire a content provided by the content server via the communication module, and a display module configured to display a list of the contents provided by the content server in accordance with a result of inquiry made by the inquiry module.

### CROSS-REFERENCE TO RELATED APPLICATIONS

This application is based upon and claims the benefit of priority from Japanese Patent Application No. 2007-256241, filed Sep. 28, 2007, the entire contents of which are incorporated herein by reference.

### BACKGROUND

1. Field

One embodiment of the invention relates to an information processing apparatus which is connectable to a network and a method of controlling the information processing apparatus.

2. Description of the Related Art

Multimedia content such as audio data and video data is widely distributed over a network. Terminal devices connectable to the network such as personal computers (PCs) and mobile information recording/reproduction devices can acquire content provided via the network by using a podcasting system or the like.

However, some content providers restrict terminal devices to acquire their content. For example, users allowed to acquire content are restricted in such a manner that a license is issued only to users who have made a contract with a provider.

Jpn. Pat. Appln. KOKAI Publication No. 2001-265584 describes an information transmission method which sets a license key to software provided by a network provider, and the license key is updated when a user creates a connection with the network provider.

However, a large number of contents are distributed over a network. Therefore, it is difficult for a user to recognize and control which of the large number of contents the user is licensed to acquire.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a schematic configuration of a multimedia reproducing apparatus (player) according to an embodiment of the present invention;

FIG. 2 is an exemplary external view showing an example of an appearance of the player;

FIG. 3 is an exemplary view showing schematically a network to which the player is connected;

FIG. 4 is an exemplary view showing an example of a startup screen displayed on an LCD after the player is turned on;

FIG. 5 is an exemplary flowchart showing an overall flow of content list display processing according to an embodiment;

FIG. 6 is an exemplary view showing an example of a portal site list displayed on the LCD;

FIG. 7 is an exemplary flowchart showing authentication processing executed between the player and a portal site;

FIG. 8 is an exemplary flowchart showing menu update processing executed between the player and the portal site;

FIG. 9 is an exemplary view showing an example of a menu screen displayed on the LCD;

FIG. 10 is an exemplary view showing an example of a content list distributed from a content server;

FIG. 11 is an exemplary flowchart showing filter processing executed by the player;

FIG. 12 is an exemplary flowchart showing license confirmation processing performed between the player and a license server;

FIG. 13 is an exemplary view showing an example of a content list screen displayed on the LCD;

FIG. 14 is an exemplary flowchart showing license confirmation processing according to a second embodiment; and

FIG. 15 is an exemplary view showing data stored in a skin determination table which the portal site holds.

### DETAILED DESCRIPTION

Various embodiments according to the invention will be described hereinafter with reference to the accompanying drawings. In general, according to one embodiment of the invention, an information processing apparatus comprises a communication module configured to communicate through a network with a content server which provides contents and a license server which manages license information of the contents provided by the content server, an inquiry module configured to inquire of the license server permission to acquire a content provided by the content server via the communication module, and a display module configured to display a list of the contents provided by the content server in accordance with a result of inquiry made by the inquiry module.

Embodiments according to the present invention will now be explained hereinafter with reference to the accompanying drawings.

### First Embodiment

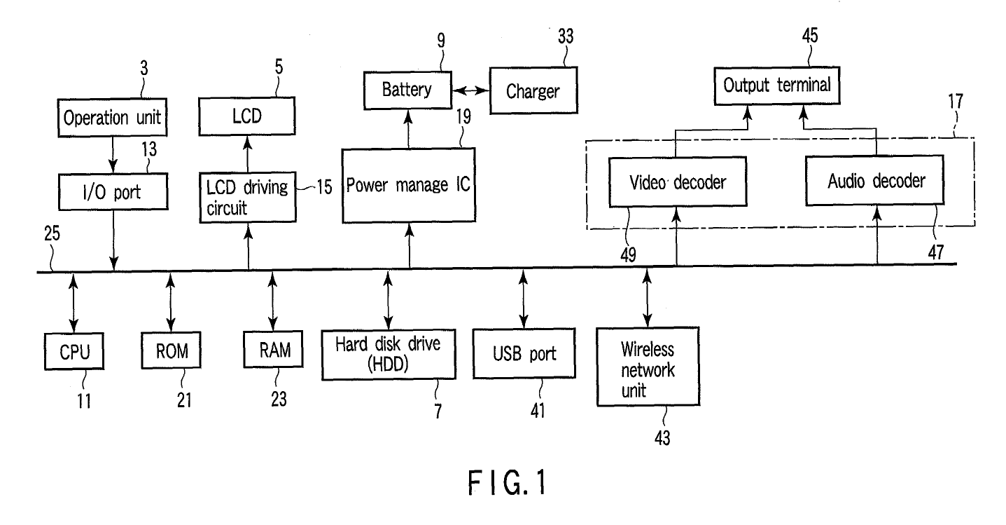

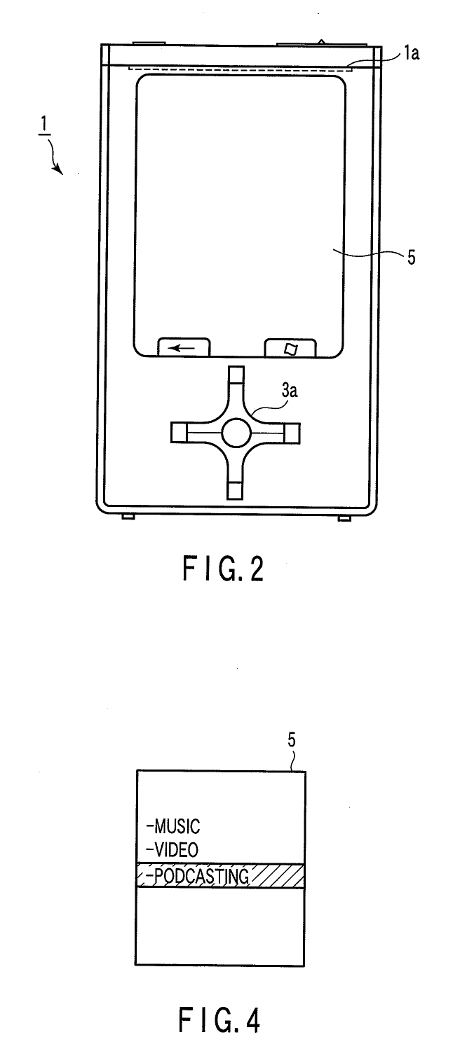

FIG. 1 is an exemplary block diagram showing an example of an electronic configuration of a portable multimedia reproducing apparatus (player) 1 according to a first embodiment of the present invention. FIG. 2 is an exemplary view showing an example of an appearance of the player 1.

The player 1 includes a CPU 11 which is a main controller. The CPU 11 controls operations of respective portions of the player 1. The respective portions of the player 1 are connected with the CPU 11 through a bus.

A user can input an operation instruction and a selection instruction by operating an operation unit 3. A control signal corresponding to the operation of the operation unit 3 by the user is supplied to the CPU 11 from an input/output (I/O) port 13. A liquid crystal display (LCD) 5 displays image data of a moving image, a still image, or textual information. The textual information to be displayed in the LCD 5 includes a file name of content being currently reproduced, and lyrics data or the like included in the content being currently reproduced. An LCD driving circuit 15 drives the LCD 5 under the control of the CPU 11.

The operation unit 3 includes a multifunction button 3a depicted in FIG. 2. The multifunction button 3a is used to enter an instruction to start or stop reproducing content such as audio data or image data, to enter an instruction to change information to be displayed in the LCD 5, and to enter an instruction to scroll the textual information displayed in the LCD 5 such as lyrics data and the file name. For example, when a center button of the multifunction button 3a is pressed, an instruction to start or stop reproducing content is transmitted to the CPU 11. Furthermore, when any one of up, down, right and left direction buttons is pressed, a control instruction to scroll an image or text displayed in the LCD 5 is transmitted to the CPU 11 in accordance with pressing of the button.

The player 1 includes an antenna unit la that is used for wireless communication with an external device. It is preferable to provide the antenna unit la at a non-metal portion in the player 1 such as circumference of the LCD 5 or the vicinity of a main power switch (not shown) on a side surface of the player 1.

A ROM 21 and a RAM 23 are connected to the CPU 11 via a control bus 25. The ROM 21 previously stores program data which is to be executed by the CPU 11 to control operations of the player 1. In the ROM 21, authentication data which is to be required to connect to an external device is stored in advance.

The RAM 23 is utilized as a work memory by the CPU 11. The RAM 23 temporarily holds control information associated with a control signal and a certain amount of data read from a hard disk drive (HDD) 7.

A battery (secondary battery) 9 is utilized as a power source when the player 1 is portably carried on. A power control IC 19 manages power provided from the battery 9, i.e., a given voltage and an allowable current. A charger 33 is connected to the battery 9. In this embodiment, from a power input unit is input a direct voltage which is pressure-reduced and converted into approximately 5V by an external power source device (not shown) to downsize the player 1. The charger 33 may be configured so as to directly accept a commercial power supply (100V AC).

The HDD 7 has a storage capacity of several gigabytes to several tens of gigabytes, and stores image data or audio data. A flash memory or solid state disk (SSD) may be provided in place of the HDD 7. The HDD 7 may be attachable to and removable from the player 1. Alternatively, a storage device such as an SD MMC memory card, memory stick, or flash ROM may be externally attached to the player 1 in place of the HDD 7.

The HDD 7 stores previously-compressed content such as audio data, image data or video data. A system such as MP3 or WMA is used to compress audio data, a system such as JPEG, GIF, or BMP is used to compress image data, and a system such as WMV or MPEG-1/2/4 is used to compress video data. Content data to be stored in the HDD 7 may be encrypted to prevent the content from being duplicated more than a predetermined number of times in such a manner that the content is only allowed to be reproduced by the player 1 itself or to be output as an analog signal to an external speaker or the like.

The CPU 11 executes a given reproduction program prestored in the ROM 21 to reproduce a data file such as an audio data file or an image data file stored in the HDD 7. Record format of content reproducible by the reproduction program is previously determined; the record format includes the above MP3, WMA, or WMV, for example. The reproduction program of contents may be stored in the HDD 7 in advance.

The HDD 7 includes a motor and requires relatively large power (large current is discharged from the battery 9) at startup. Therefore, when reading data from the HDD 7, the power consumption is reduced in such a manner that a certain amount of data is read from the HDD 7 and temporarily stored in the RAM 23 (buffering), then driving of the HDD 7 is stopped. When other storage device such as a flash ROM or an SD memory is used in place of the HDD 7, read-out speed from such storage device is slower than read-out speed from the RAM 23. Therefore, a certain amount of data is read from the storage device and buffered in the RAM 23, thereby speeding up data reading.

An output unit 17 converts image data or audio data stored in the HDD 7 into an analog output under the control of the CPU 11. An output terminal 45 is used for an ordinary analog output.

An audio decoder 47 which is provided in the output unit 17 demodulates audio data into an analog signal and sends the analog signal to the output terminal 45. In addition, a video decoder 49 which is provided in the output unit 17 performs digital-to-analog conversion on a video signal and outputs the converted video signal to the output terminal 45. Headphones, speakers having an amplifying function, a monitor device, or an image receiver may be connected to the output terminal 45, and an audio output or a video output can be heard or viewed. An audio output from the output terminal 45 may be input to an amplification device (not shown), and a speaker (not shown) may be connected to the amplification device to obtain a larger audio volume. The audio decoder 47 can converts analog signal which is input directly form a microphone input plug or a line input plug (external input plug) into a digital signal and send the digital signal to the CPU 11.

A Universal Serial Bus (USB) port 41 and a wireless network unit (communication unit) 43 are also connected with the CPU 11.

The player 1 can be connected to an external device (not shown) through the USB port 41 and send data to and receive data from the external device. For example, image data or audio data is supplied to the player 1 from the external device such as a personal computer (PC) through the USB port 41. Furthermore, image data or audio data stored in the HDD 7 may be supplied to the external device through the USB port 41. Audio data may be transmitted through the USB port 41 from the player 1 to the external device such as a USB speaker or a device which is dedicated to audio reproduction and containing a semiconductor memory therein (e.g., USB flash memory player). The USB port 41 is also used to input a music/audio signal from the external device, e.g., a microphone.

Data communication between the player 1 and the external device may utilize the wireless network unit 43. Image data or audio data is supplied to the player 1 through the wireless network unit 43 from the external device. Image data or audio data stored in the HDD 7 is supplied to the external device through the wireless network unit 43. The wireless network unit 43 may comply with the Bluetooth (registered trademark) which is compatible with a protocol of communication standard using electric waves in 2.4 GHz band, or may comply with a general-purpose wireless local area network (wireless LAN) which is compatible with IEEE802.11a/b/g/n. In addition, the wireless network unit 43 may comply with both of the Bluetooth and the general-purpose wireless LAN. The player 1 can communicate wirelessly with a server computer or a personal computer which is placed within a certain distance range from the player 1 and satisfies a given condition.

The player 1 can connect to a network such as the Internet via the wireless network unit 43. Moreover, the player 1 can download content such as an audio data file and an image data file provided over the network and store the downloaded content in the HDD 7. The player 1 can reproduce the content stored in the HDD 7.

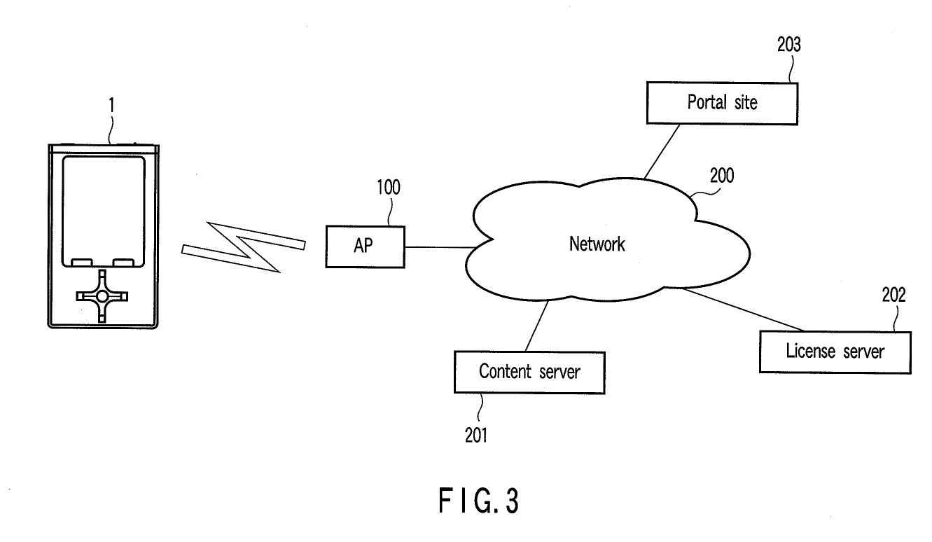

FIG. 3 is an exemplary view showing schematically a network 200 to which the player 1 is connected.

The player 1 is connected to an access point (AP) 100 via the wireless network unit 43. The access point 100 is connected to the network 200. In addition, a content server 201, a license server 202, and a portal site 203 are connected to the network 200. The player 1 can exchange data with the content server 201, the license server 202, and the portal site 203 through the network 200.

The content server 201 is a server apparatus which distributes contents such as an audio data file and an image data file. The content server 201 includes a common computer or the like. The player 1 can acquire a content provided by the content server 201 through the network 200. However, there may be a case in which the content server 201 limits users allowed to acquire content. Accordingly, a user needs to obtain acquisition permission (or license) from the provider of the content server 201 in advance.

The license server 202 is a server apparatus which holds information (license information) about which content is licensed to which user. The license server 202 includes a common computer or the like. The license information includes user ID and corresponding content ID. The user ID is issued by the provider of the content server 201 to a user who is licensed to utilize a service in order to identify the user. The content ID is data to identify content. That is, the license server 202 stores user ID in association with content ID of a content which the user is permitted to obtain. The same content ID may be assigned to a plurality of related contents (for example, music data by the same artist). The license server 202 manages license information so that the latest license information is always maintained.

The player 1 stores the user ID issued by the content server 201 in the ROM 21. When the user ID is not stored in the ROM 21, the user may enter the user ID each time the user ID is requested from the content server 201 and the license server 202.

Information security can be enhanced by configuring the content server 201 and the license server 202 as independent apparatuses.

The portal site 203 is, for example, a Web site or the like, and provides the player 1 with a link to content server 201. Usually, a number of content servers 201 are connected to the network 200. The player 1 may have difficulty in accessing a desired content server among a number of content servers 201. Therefore, the portal site 203 provides the player 1 with a link list to content server(s) 201 so that the player 1 can easily access the desired content server 201.

The portal site 203 holds menu screen data and update data of the menu screen data. The portal site 203 transmits the menu screen data and the update data to the player 1 when requested. The menu screen data contains a list of links to content servers 201 (link list) and is displayed on the LCD 5 of the player 1 as a menu screen. The update data indicates the last update date and time of the menu screen data.

In some cases, the portal site 203 imposes restrictions on users for whom the menu screen data is provided. A user of the player 1 also needs to obtain service use permission from the provider of the portal site 203 in advance. In such cases, the portal site 203 provides the player 1 with menu screen information after authenticating the user of the player 1 as a licensed user. Authentication data for identifying the player 1 which is permitted to utilize the service is stored in the portal site 203. In the present embodiment, a model name and a serial number of the player 1 are used as authentication data.

Generally, a number of the portal sites 203 are connected to the network 200. Addresses of the portal sites 203 on the network are registered (stored) in the ROM 21 of the player 1 in advance. In the case where a registered portal site 203 imposes restrictions on users, the address of the portal site 203 is stored in the ROM 21 with a flag indicating user restrictions attached thereto. Upon receiving menu screen data, the CPU 11 also stores the received menu screen data and update data of the received menu screen in the ROM 21.

Over the network, a number of contents are distributed. Consequently, it is difficult for a user to recognize and manage which of the contents the user is licensed to acquire. Hereinafter, processing for displaying a content list on the LCD 5 so that contents allowed to acquire can be easily recognized will be described.

FIG. 4 is an exemplary view showing an example of a startup screen displayed on the LCD 5 after the player 1 is turned on. In the example shown in FIG. 4, three items of “MUSIC”, “VIDEO”, and “PODCASTING” are displayed in the startup screen. The user can select any item from the displayed items by operating the multifunction button 3a. When “MUSIC” is selected, a given audio reproduction program is started, and when “VIDEO” is selected, a given reproduction program for a moving image is started. When the user selects “PODCASTING”, a program for displaying content list to acquire content via the network is started.

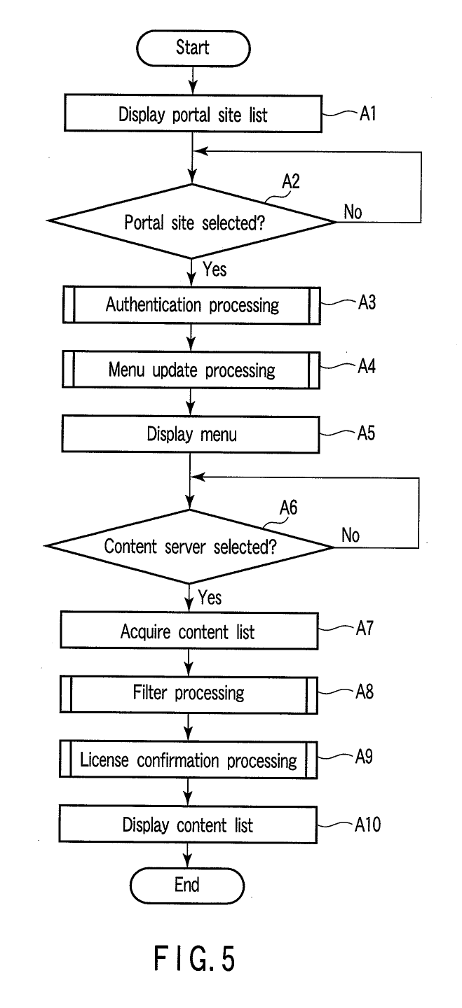

FIG. 5 is an exemplary flowchart showing an overall flow of content list display processing according to an embodiment.

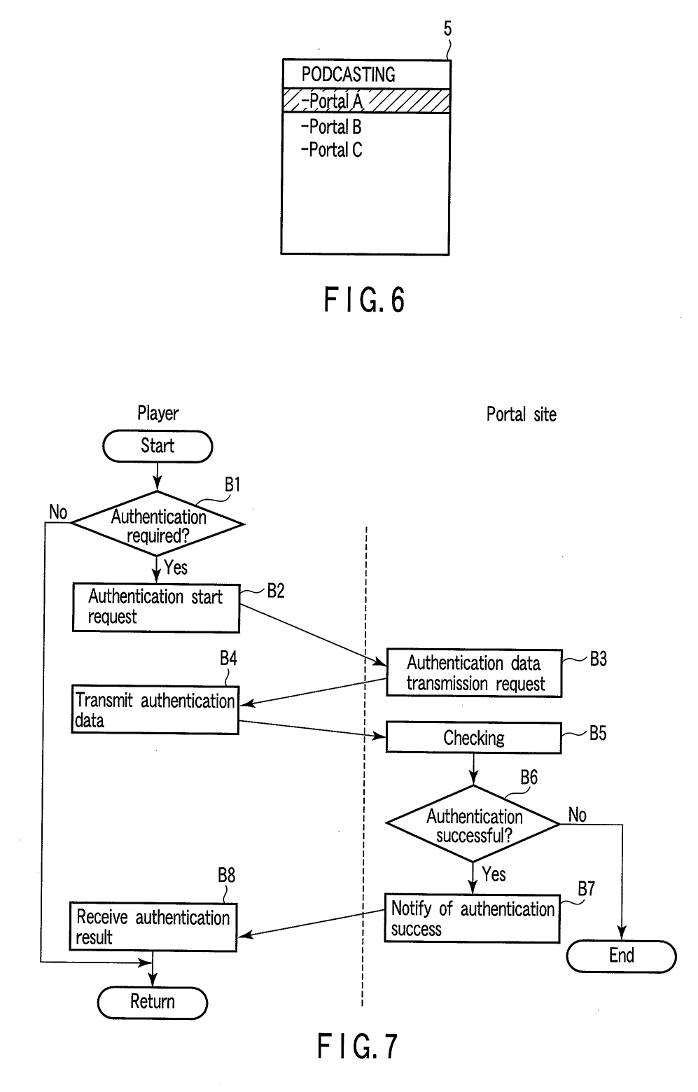

When the user selects the item of “PODCASTING” from the start screen displayed on the LCD 5 (see FIG. 4), the CPU 11 displays a list of portal sites 203 whose addresses are stored in the ROM 21 on the display screen of the LCD 5 (block A1). FIG. 6 is an exemplary view showing an example of a portal site list. In the example shown in FIG. 6, three portal sites including “Portal A”, “Portal B”, and “Portal C” are displayed in the portal site list.

After the portal site list is displayed, the CPU 11 waits until the user operates the multifunction button 3a and selects one from the portal sites 203 displayed on the LCD 5 (block A2). When the user selects one portal site 203 from the portal site list (Yes in block A2), the CPU 11 starts authentication processing with the selected portal site 203 (block A3).

In some cases the portal site 203 imposes restrictions on users to provide the service (provision of a link list). In such cases, the user of the player 1 needs to obtain permission to use the service from the provider of the portal site 203 in advance. In authentication processing (block A3), the portal site 203, which imposes restrictions on users, checks authentication data transmitted from the player 1 against stored authentication data and determines whether or not the user of the player 1 has obtained the permission to use the service. In the present embodiment, the model name and the serial number of the player 1 are used as authentication data.

FIG. 7 is an exemplary flowchart showing authentication processing executed between the player 1 and the portal site 203.

In the authentication processing, the CPU 11 of the player 1 determines whether or not the selected portal site 203 imposes restrictions on users and requires authentication to be executed (block B1). That is, the CPU 11 reads the address of the selected portal site 203 from the ROM 21 and determines whether or not a flag indicating user restrictions is attached to the read address.

When no user restriction flag is attached, it is determined that the selected portal site 203 does not impose restrictions on users and authentication is not required (No in block B1). When the selected portal site 203 imposes no restrictions on users, the authentication processing described below need not be performed. Therefore, the flow returns to the flowchart of FIG. 5.

On the other hand, when the user restriction flag is attached to the read address, it is determined that the selected portal site 203 imposes restrictions on users and authentication is required (Yes in block B1). Then, the CPU 11 transmits a request to start authentication to the read address via the wireless network unit 43 (block B2).

In response to the request from the player 1, the portal site 203 requests the player 1 to transmit the authentication data (block B3). In the present embodiment, the model name and the serial number of the player 1 are used as authentication data.

The CPU 11 of the player 1 transmits the authentication data (model name and serial number) to the portal site 203 (block B4). The portal site 203 checks prestored authentication data of players which have permission to use the service against the transmitted authentication data (block B5).

When, as a result of the check, the authentication data transmitted from the player 1 does not match the authentication data prestored in the portal site 203, the portal site 203 determines that the authentication results in failure (No in block B6). When the authentication result is failure (No in block B6), it is determined that the player 1 does not have the permission to use the service provided by the selected portal site 203 and the content list display processing terminates. Then, predetermined processing such as selecting another portal site will be performed.

When, as a result of the check, the authentication data transmitted from the player 1 matches authentication data prestored in the portal site 203, the portal site 203 determines that the authentication is successful (Yes in step B6). When the authentication is successful (Yes in block B6), the portal site 203 notifies the player 1 of the success in the authentication (block B7).

Upon receiving the result of the authentication via the wireless network unit 43 (block B8), the CPU 11 of the player 1 returns to processing of the flowchart shown in FIG. 5.

When the authentication processing is completed and it is determined that the player 1 has obtained permission to use the service from the selected portal site 203, the CPU 11 starts menu update processing (block A4 in FIG. 5) to acquire the latest menu screen data from the selected portal site 203.

The selected portal site 203 provides the player 1 with the menu screen data containing a link list to a content server or content servers 201. The menu update processing in block A4 provides the latest menu screen data for the player 1.

When the player 1 has already received menu screen data provided by the selected portal site 203, the previous menu screen data has been stored in the ROM 21 of the player 1. The menu screen data stored in the ROM 21 can be updated to the latest menu screen data by the menu update processing in block A4.

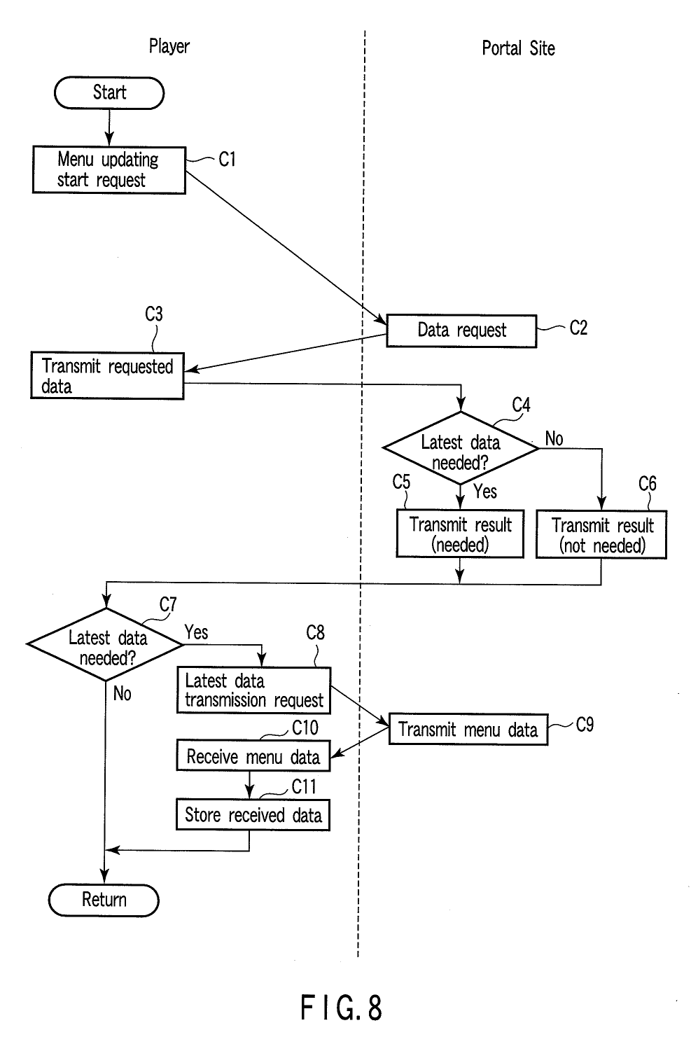

FIG. 8 is an exemplary flowchart showing menu update processing executed between the player 1 and the portal site 203.

The CPU 11 of the player 1 transmits a request to start the menu update processing to the selected portal site 203 from the wireless network unit 43 (block C1).

The portal site 203 requests the player 1 to transmit the update data of the menu screen data which the player 1 stores (block C2). The update data of the menu screen data indicates the last update date and time of the menu screen data.

The CPU 11 of the player 1 transmits the update data stored in the ROM 21 to the portal site 203 from the wireless network unit 43 (block C3). When neither menu screen data nor update data of the screen data is stored in the ROM 21, a notification of the fact is sent to the portal site 203.

The portal site 203 determines whether or not the player 1 needs to obtain the latest menu screen data (block C4). When the update date and time indicated by the update data which is transmitted from the player 1 is older than the update time and date indicated by the update data which is stored in the portal site 203, the player 1 has need to obtain the latest menu screen data. In addition, when the notification that the menu screen data is not stored in the ROM 21 has been sent to the portal site 203, the player 1 also needs to obtain the latest menu screen data.

When the player 1 needs to obtain the latest menu screen data (Yes in block C4), the portal site 203 notifies the player 1 that the player 1 needs to obtain the latest menu screen data (block C5). On the other hand, when the player 1 need not obtain the latest menu screen data (No in block C4), the portal site 203 notifies the player 1 that the latest menu screen data is not needed (block C6).

Subsequently, the CPU 11 of the player 1 determines whether or not the notification sent from the portal site 203 indicates a need to obtain the latest menu screen data (block C7).

When the notification from the portal site 203 indicates that obtaining the latest data is not needed (No in block C7), the menu screen data stored in the ROM 21 of the player 1 is the latest data. Thus, the CPU 11 returns to the flowchart of FIG. 5 without obtaining the menu screen data.

When the notification from the portal site 203 indicates that obtaining the latest data is needed (Yes in block C7), the CPU 11 of the player 1 requests the latest menu screen data of the portal site 203 (block C8). In response to the request from the player 1, the portal site 203 transmits the latest menu screen data to the player 1 (block C9). In addition, new update data of the menu screen data is also transmitted to the player 1.

The portal site 203 may provide the player 1 with the menu screen data including link to each content server 201 with a flag attached thereto. The flag indicates whether the corresponding content server 201 imposes restrictions on users who are allowed to acquire content or not, or whether the corresponding content server 201 is charged or not.

The menu screen data and the update data transmitted from the portal site 203 are received through the wireless network unit 43 of the player 1 (block C10). The CPU 11 of the player 1 stores the received menu screen data and the update data in the ROM 21 (block C11). Then, the CPU 11 returns to the flowchart of FIG. 5.

As a result of the menu update processing, the latest menu screen data is stored in the ROM 21 of the player 1. After acquiring the latest menu screen data, the CPU 11 of the player 1 displays the menu screen including the link list on the display screen of the LCD 5 by based on the latest menu screen data (block A5 in FIG. 5).

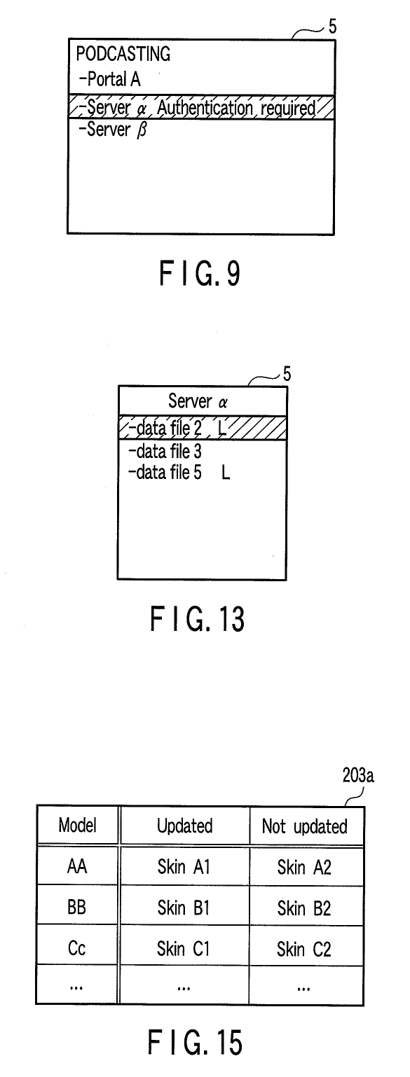

FIG. 9 is an exemplary view showing an example of the menu screen displayed on the LCD 5. In the example shown in FIG. 9, the menu screen provided by a portal site (Portal A) is displayed. The link list of FIG. 9 includes two servers of “content server α” and “content server β” as the content servers 201. When, as shown in FIG. 9, a flag indicating user restrictions is attached to the link to content server α provided by the portal site 203, an indicator of “Authentication required” which indicates authentication processing is required is additionally displayed.

In addition, when the portal site 203 provides a link to content server 201 with a flag attached thereto indicating whether or not the content server 201 is charged, the display on the LCD 5 can conform to the flag so that, for example, it is explicitly shown that the content server is charged.

Next, the CPU 11 of the player 1 waits until the user selects a content server from the link list by operating the multifunction button 3a of the operation unit 3 (block A6 in FIG. 5). When the user selects one content server 201 (Yes in block A6), the CPU 11 of the player 1 acquires a content list from the selected content server 201 (block A7).

In content list acquisition processing in block A7, the CPU 11 acquires, from the selected content server 201, a content list 50 of contents provided by the content server 201. The content list is described, for example, in RSS format, which is the XML notation for content distribution. However, the description format of the content list is not limited to the RSS format and may be the Atom format or others.

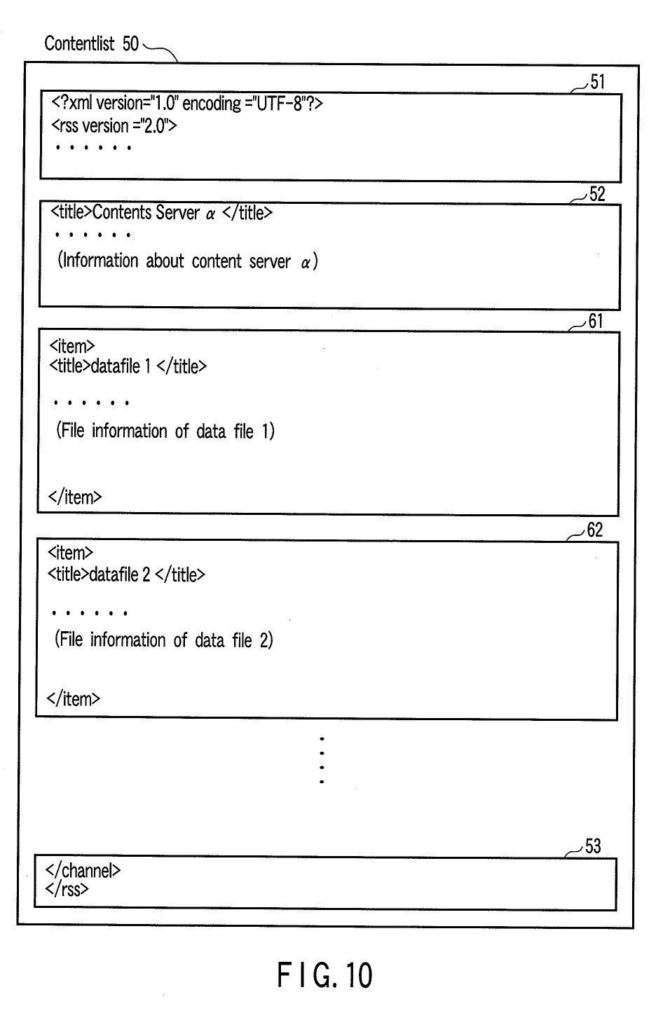

FIG. 10 is an exemplary view showing an example of the content list 50 described in the RSS format and distributed from a content server.

In FIG. 10, the example of the content list 50 provided from content server α (Server α) is shown. The content list 50 includes a start declaration 51, server information 52, an end declaration 53, and content information parts 6₁, 6₂, . . . , 6ₙ (n is an arbitrary number). When the content list is described in the RSS format, the start declaration 51 includes an XML declaration which declares the list is an XML document, RSS version information and the like. In the server information 52, information (meta-information) about content server α is described, such as the address of the content server α, descriptive information which explains about content server α, and the address of the corresponding license server 202. The end declaration 53 indicates the end of the content list 50.

Items of information of “data file 1 (datafile1)”, “data file 2 (datafile2)”, . . . which are contents provided by content server α over the network are described in the content information parts 6₁, 6₂, . . . between the server information 52 and the end declaration 53.

Information of the data file 1 is described in the content information part 6₁. The content information part 6₁ includes information of the data file 1 such as the file name, descriptive information, date and time of distribution, URL, file size, file type (recording format), and content ID. Information of the data file 2 is described in the content information part 6₂. Similarly, items of information of the data files 3, 4, . . . are described in the content information parts (not shown) 6₃, 6₄, . . . , respectively.

After acquiring the content list 50 from the content server 201 in block A7, the CPU 11 of the player 1 subjects the acquired content list 50 to filter processing (block A8 in FIG. 5).

In the ROM 21 (or the HDD 7) of the player 1, a reproduction program of content is stored. Recording formats of content that can be reproduced by the reproduction program are predetermined. Thus, even though a content is acquired from the content server 201, the content may not be reproducible depending on the recording format thereof.

Moreover, even when the recording format is reproducible by the player 1, the content may not be reproduced by the player 1. For example, image data of a higher resolution than that of the LCD 5 cannot be reproduced by the player 1. In addition, there is an upper limit to the bit rate that can be reproduced by the player 1. In the filter processing (block A8), file information of such a content that cannot be reproduced by the player 1 is deleted from the content list 50.

Information about a resolution and a bit rate of a content is contained in profile data held by the content itself. The profile data is smaller than 1 KB (kilobyte) in size and is usually arranged in a head part of the content. Thus, profile data can be extracted by selectively downloading the first 1 KB of the content. In the present embodiment, even when a user is not allowed to acquire a content, the first 1 KB of the content can be downloaded to extract profile data.

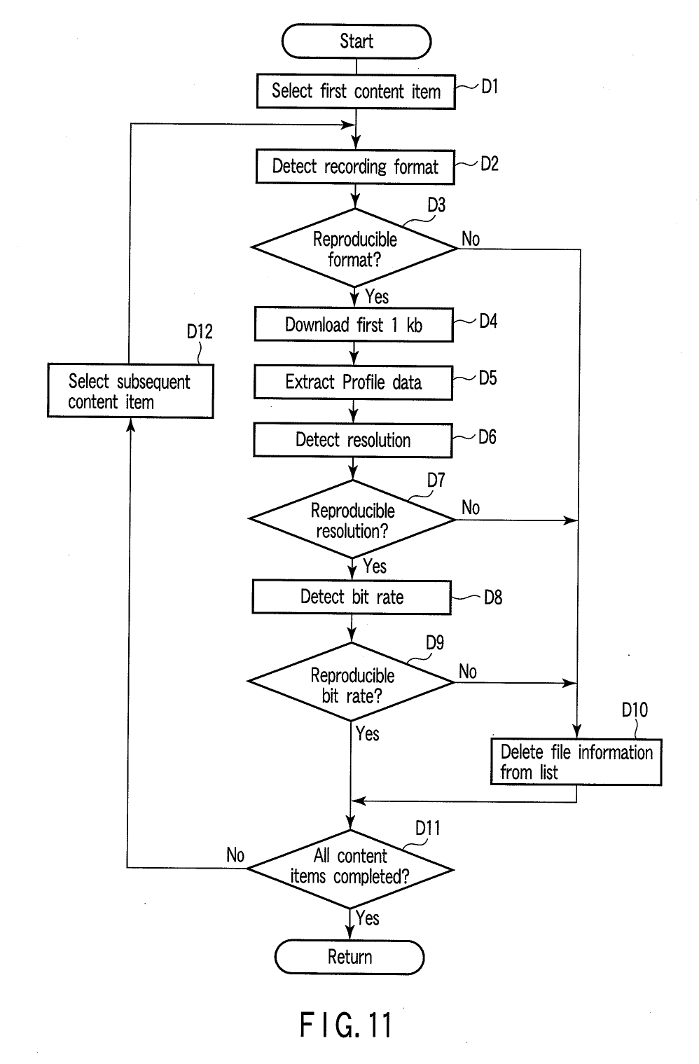

FIG. 11 is an exemplary flowchart showing filter processing executed by the player 1.

Firstly, the CPU 11 selects the first content information part 6₁ and the corresponding content as a processing target from the content information parts 6₁, 6₂, . . . contained in the acquired content list 50 (block D1). For example, in the example of the content list 50 shown in FIG. 10, the data file 1 corresponding to the first content information part 6₁ is selected as the processing target.

Next, the CPU 11 detects the recording format of the content selected from the selected content information part 6₁ (block D2). Then, the CPU 11 determines whether or not the detected recording format is a format that can be reproduced by the player 1 (block D3).

When the detected recording format is a format that cannot be reproduced by the player 1 (No in block D3), the CPU 11 deletes the selected content information part 6₁ from the content list 50 (block D10).

On the other hand, when the detected recording format is a format that can be reproduced by the player 1 (Yes in block D3), the CPU 11 acquires the first 1 KB data of the content corresponding to the content information part 6₁ from the content server 201 via the wireless network unit 43 (block D4). Then, the CPU 11 extracts profile data from the acquired 1 KB data (block D5).

The profile data contains information about the resolution and the bit rate of the content. The CPU 11 detects the resolution data from the profile data (block D6). Then, the CPU 11 determines whether or not the detected resolution is a resolution that the LCD 5 can display (block D7).

When the detected resolution is a resolution that the LCD 5 cannot display (No in block D7), the CPU 11 deletes the selected content information part 6₁ from the content list 50 (block D10).

When the detected resolution is a resolution that the LCD 5 can display (Yes in block D7), the CPU 11 subsequently detects bit rate data from the profile data (block D8). Then, the CPU 11 determines whether or not the detected bit rate is a bit rate reproducible by the player 1 (block D9).

When the detected bit rate is not reproducible by the player 1 (No in block D9), the CPU 11 deletes the selected content information part 6₁ from the content list 50 (block D10). Then, the CPU 11 determines whether or not the filter processing has been completed for all the content information parts 6₁, 6₂, . . . contained in the content list 50 (block D11).

When there remains any content information part which has not been subjected to the filter processing (No in block D11), the CPU 11 selects a subsequent content information part as a processing target from the content list 50 (block D12) and repeats processing of block D2 and thereafter.

When the filter processing is completed for all the content information parts 6₁, 6₂, . . . contained in the content list 50 (Yes in block D11), the flow returns to processing of the flowchart in FIG. 5.

As a result of the filter processing described above, information about a content which the player 1 cannot reproduce is removed from the content list 50. Only file information of contents that can be reproduced by the player 1 remains in the content list 50.

When the filter processing is completed, the CPU 11 of the player 1 executes license confirmation processing on the content list 50 (block A9 in FIG. 5).

In some cases, the content server 201 may impose restrictions on users to provide contents, and a user needs to obtain permission to use the service (to acquire contents) from the provider of the content server 201 in advance. The license server 202 manages user ID issued to a user who is permitted to use the service. In association with the user ID, the license server 202 also stores content ID indicating a content or contents which the user can acquire. The same content ID may be assigned to a plurality of related contents (for example, music data by the same artist). The license server 202 manages license information so that the latest license information is always maintained. In the license confirmation processing (block A9), the player 1 inquires of the license server 202 whether or not the player 1 is permitted (or licensed) to acquire a content contained in the content list 50. License information obtained as a result of the inquiry is written into each of the content information parts 6₁, 6₂, . . . of the content list 50.

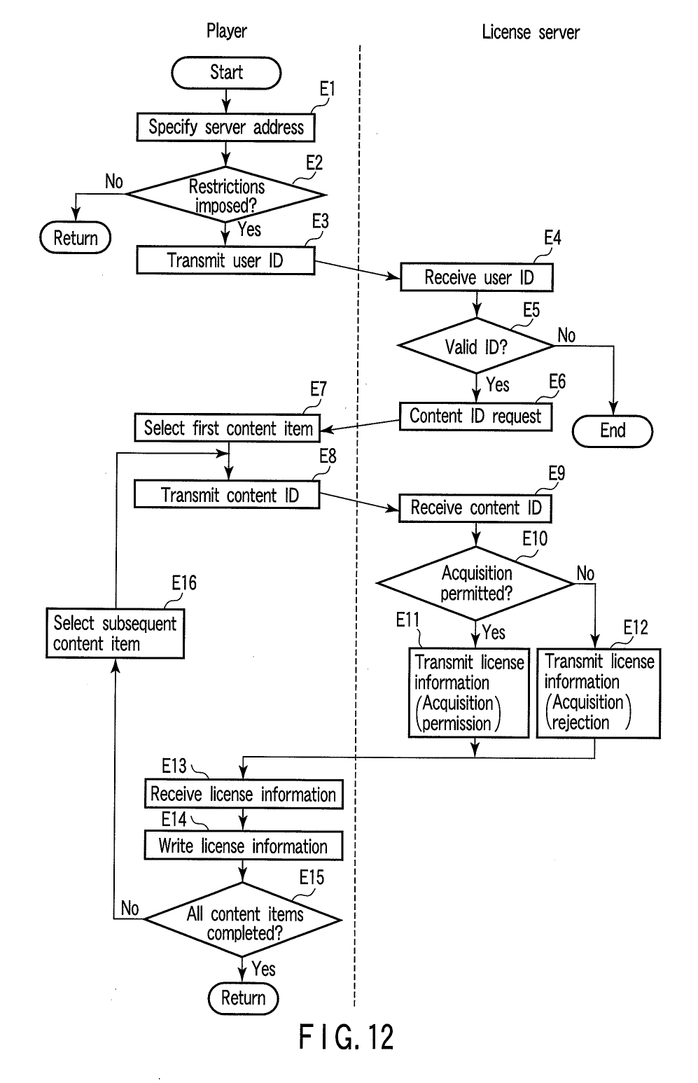

FIG. 12 is an exemplary flowchart showing license confirmation processing performed between the player 1 and the license server 202.

Firstly, the CPU 11 of the player 1 specifies the address of the license server 202 (block E1). The address of the license server 202 is contained in the content list 50 transmitted from the selected content server 201. For example, in the content list 50 shown in FIG. 10, the address of the license server 202 corresponding to the content server 201 is also described in the server information 52 in which information about the content server 201 is described. The CPU 11 detects from the server information 52 the address of the license server 202 corresponding to the content server 201 selected in block A6. If the address of the license server 202 is not contained in the content list 50, the address of the license server 202 may be inquired of the selected content server 201.

Next, the CPU 11 determines whether or not the content server 201 imposes restrictions on users (block E2). Whether the content server 201 imposes restrictions on users or not can be determined based on information contained in the server information 52 of the content list 50. When the content server 201 does not impose restrictions on users to acquire a content (No in block E2), the flow returns to the flowchart of FIG. 5.

On the other hand, when the content server 201 imposes restrictions on users to acquire content (Yes in block E2), the CPU 11 of the player 1 reads user ID stored in the ROM 21 and transmits the read user ID to the specified address (block E3). Alternatively, the user may be prompted to enter the user ID and the entered user ID may be transmitted to the specified address.

Upon receiving the user ID (block E4), the license server 202 determines whether or not the received user ID is a valid user ID issued by the content server 201 (block E5). When the received user ID is different from user IDs which the license server 202 manages, it is determined that the received user ID is not a valid user ID.

When it is determined that the received user ID is not a valid user ID (No in block E5), the user of the player 1 is considered not licensed by the content server 201 and the content list display processing terminates. Then, predetermined processing, e.g., license confirmation processing with another license server will be performed.

On the other hand, when it is determined that the received user ID is a valid user ID (Yes in block E5), the license server 202 requests the player 1 to transmit content ID of a content (block E6).

Then, the CPU 11 of the player 1 selects the first content information part 6₁ and the corresponding content as a processing target from the content information parts 6₁, 6₂, . . . contained in the acquired content list 50 (block E7). In the case where the content information part 6₁ has been deleted by the filter processing in block A8, content information part at the head of the content list 50 other than the first content information part 6₁ is selected.

The CPU 11 reads content ID contained in the selected content information part 6₁ (or the other selected content information part) and transmits the read content ID to the license server 202 from the wireless network unit 43 (block E8).

After receiving the content ID (block E9), the license server 202 determines whether or not the user of the player 1 is permitted (licensed) to acquire the content corresponding to the content ID (block E10). The license server 202 stores content IDs of contents allowed for the user to acquire in association with the user ID. The license server 202 makes the determination of block E10 by means of checking data stored therein against the data transmitted from the player 1.

When it is determined that the user is permitted to acquire the content corresponding to the content ID transmitted from the player 1 (Yes in block E10), the license server 202 transmits to the player 1 license information (Acquisition permission) indicating that the content is permitted to acquire (block E11). On the other hand, when to acquire the content is not permitted for the user (No in block E10), the license server 202 transmits to the player 1 license information (Acquisition rejection) indicating that the content is not allowed to acquire (block E12).

The player 1 receives the license information transmitted from the license server 202 via the wireless network unit 43 (block E13). The CPU 11 of the player 1 writes the received license information into the selected first content information part 6₁ (or the other selected content information part) at the head of the content list 50 (block E14). That is, in the case where acquisition of the content is permitted, the license information indicating acquisition permission is written; however, in the case where acquisition of the content is not permitted, the license information indicating acquisition rejection is written.

Then, the CPU 11 determines whether or not the license confirmation processing has been completed for all the content information parts 6₁, 6₂, . . . contained in the content list 50 (block E15).

When there remains any content information part on which the license confirmation processing has not been executed (No in block E15), the CPU 11 selects a subsequent content information part as a processing target from the content list 50 (block E16) and repeats processing of block E8 and thereafter.

When the license confirmation processing is completed for all the content information parts 6₁, 6₂, . . . contained in the content list 50 (Yes in block E15), the flow returns to processing of the flowchart shown in FIG. 5.

As a result of the license confirmation processing described above, the license information indicating whether the user of the player 1 is licensed to acquire a content or not is written in each of the content information parts of the content list 50.

When the license confirmation processing is completed, a list of contents is displayed based on the content list 50 (block A10 in FIG. 5), and then the content list display processing terminates.

The CPU 11 can display differently a content which is allowed to acquire from a content which is not allowed to acquire, with reference to the license information written in each of the content information parts 6₁, 6₂, . . . .

FIG. 13 is an exemplary view showing an example of the content list screen displayed on the LCD 5. In the example shown in FIG. 13, contents that can be reproduced by the player 1, “data file 2”, “data file 3”, and “data file 5” are listed out of the contents distributed from content server α (Server α). In the content list 50 in this example, the license information (acquisition permission) is written in the content information part 6₂ (corresponding to the data file 2) and the content information part 6₅ (corresponding to the data file 5). Therefore, a mark L is attached to the data file 2 and the data file 5, which the user is permitted to acquire. The user can easily identify which file is allowed to acquire based on the marks.

The user can select one or more contents by operating the multifunction button 3a from the content list displayed on the LCD 5 by the content list display processing. When a content which is allowed to acquire is selected, the selected content is downloaded from the content server 201. When a content which is not allowed to acquire is selected, the player 1 does not download the selected content.

Alternatively, when a content is selected, the player 1 may transmit license information of the selected content to the content server 201. The content server 201 can perform processing based on the transmitted license information.

The content server 201 allows downloading the content only when the license information transmitted from the player 1 indicates that acquisition of the content is permitted. To download a content from the content server 201, it is required to transmit, to the content server 201, license information which has been transmitted from the license server 202 and indicates that it is allowed to acquire the content. That is, the license information transmitted from the license server 202 functions as a key to downloading the content. Therefore, the license information may be encrypted to enhance security of transmitting the license. On the other hand, when the license information transmitted from the player 1 to the content server 201 does not indicates acquisition permission, the content server 201 sends screen data for prompting the user to obtain the permission. The player 1 proceeds to permission obtaining processing according to a link to the predetermined permission obtaining processing contained in the screen data.

According to the multimedia reproduction apparatus (player) 1 of the present embodiment, a list of contents which a content server distributes can be acquired from the content server. A content that cannot be reproduced by the player 1 can be deleted from the content list. Moreover, it can be inquired from a license server whether a content in the content list is allowed to acquire or not, and a result of the inquiry can be added to the content list.

Thus, when the content list is displayed, a content which is allowed to acquire and a content which is not allowed to acquire can be distinguished. Therefore, the user can easily recognize which content is allowed to acquire from the contents provided by the content server 201.

When any content is selected from the content list, processing which accords with license information of the content can be executed. Thus, processing to be executed when a content which is allowed to acquire is selected can be differentiated from processing to be executed when a content which is not allowed to acquire is selected.

In the present embodiment, user ID issued by the content server 201 is stored in the ROM 21, but the user ID may be stored in the HDD 7 in advance. Moreover, an address of a portal site, menu screen data acquired from content server 201 and update data thereof, which are stored in the ROM 21, can also be stored in the HDD 7.

In the present embodiment, the player 1 acquires the latest link list by the menu update processing (block A4 in FIG. 5, flowchart in FIG. 8). Thus, even when an address of content server 201 has changed, the player 1 can easily access the content server 201 based on the latest menu screen data provided by the portal site 203.

Furthermore, in the present embodiment, the content list 50 is acquired from the content server 201 in block A7 of FIG. 5. Even a user who is not licensed by the content server 201 can also acquire the content list 50. When there is any content in the acquired content list 50 that interests a user, the user can start processing to obtain a license from the content server 201.

In the present embodiment, the content list 50 acquired from the content server 201 contains information such as an address of corresponding license server 202; however, information about the license server 202 may be provided in a different manner.

In the present embodiment, the content list 50 acquired from the content server 201 is described in the RSS or Atom format, but any other format that can describe information of contents provided by the content server 201 may also be used.

In the filter processing (block A8 in FIG. 5 and the flowchart in FIG. 11), profile data of a content which is not licensed to a user can be acquired by the user. However, order of the filter processing (block A8 in FIG. 5) and the license confirmation processing (block A9 in FIG. 5) may be interchanged, and merely first 1 KB data of a content to which license information of acquisition permission is attached by the license confirmation processing may be downloaded.

In the present embodiment, a content which is allowed for a user to acquire is displayed with a mark attached thereto; therefore, the content can be distinguished from a content which is not allowed to acquire (block A10 in FIG. 5). However, the display distinction is not limited to this. A content which is not allowed to acquire can be displayed with a mark attached thereto, or can be prevented from being displayed in the list.

In the authentication processing (block A3 in FIG. 5, flowchart in FIG. 7) of the present embodiment, the model name and serial number of the player 1 are utilized as authentication data; however, other information may also be used as the authentication data.

Next, other embodiments of the present invention will be described. In the embodiments below, corresponding reference numbers are attached to corresponding components in the first embodiment and a detailed description thereof is omitted. The configuration of the other embodiments is represented by the block diagram shown in FIG. 1.

### Second Embodiment

In the license confirmation processing (block A9 in FIG. 5, flowchart in FIG. 12) of the first embodiment, it is determined whether or not a user of the player 1 is permitted to acquire each of all contents contained in the content list 50 one by one. In the license confirmation processing of the present embodiment, determination is made not only as to whether a content is permitted to acquire, but also as to whether the permission has any term of validity and whether the term of validity has expired.

In the first embodiment, information managed by the license server 202 includes user ID of a user permitted to acquire a content by the content server 201 and the content ID of the content allowed for the user to acquire. In addition, the license server 202 manages data on a term of validity of a permission to acquire to a content in association with the user ID and the content ID, in the present embodiment.

The overall flow of content list display processing in the second embodiment is represented, as in the first embodiment, by the flowchart shown in FIG. 5.

When the user selects the item “PODCASTING” from the start screen (see FIG. 4) displayed on the LCD 5, the CPU 11 displays the list of the portal sites 203 whose addresses are stored in the ROM 21 on the display screen of the LCD 5 (block A1).

After the portal site list is displayed, the CPU 11 waits until the user operates the multifunction button 3a to select one from the portal sites 203 displayed on the LCD 5 (block A2). When the user selects one portal site 203 from the portal site list (YES in block A2), the CPU 11 starts authentication processing with the selected portal site 203 (block A3). As in the first embodiment, the authentication processing in block A3 is represented by the flowchart of FIG. 7.

In this authentication processing (block A3, flowchart in FIG. 7), the selected portal site 203 checks authentication data transmitted from the player 1 against stored authentication data and determines whether or not the user of the player 1 has obtained the permission to use the service. Also in the present embodiment, the model name and the serial number of the player 1 are used as authentication data.

When the authentication processing is completed and it is determined that the user of the player 1 has obtained permission to use the service from the selected portal site 203, the CPU 11 starts menu update processing (block A4) to acquire the latest menu screen data from the selected portal site 203. The menu update processing in block A4 is represented, as in the first embodiment, by the flowchart shown in FIG. 8.

The latest menu screen data is provided to the player 1 from the selected portal site 203 by the menu update processing (block A4 in FIG. 5, flowchart in FIG. 8). As a result of the menu update processing, the latest menu screen data is stored in the ROM 21 of the player 1. After acquiring the latest menu screen data, the CPU 11 of the player 1 displays the menu screen including a link list on the display screen of the LCD 5 using the latest menu screen data (block A5).

Next, the CPU 11 of the player 1 waits until the user selects a content server from the link list by operating the multifunction button 3a of the operation unit 3 (block A6). When the user selects one content server 201 (YES in block A6), the CPU 11 of the player 1 acquires a content list from the selected content server 201 (block A7).

As in the first embodiment, the content list 50 acquired from the selected content server 201 includes, as shown in FIG. 10, for example, the start declaration 51, the server information 52, the end declaration 53, and the content information parts 6₁, 6₂, . . . , 6ₙ (n is an arbitrary number).

When the content list 50 is acquired from the selected content server 201, the CPU 11 of the player 1 subjects the acquired content list 50 to filter processing (block A8 in FIG. 5). The filter processing is represented, as in the first embodiment, by the flowchart shown in FIG. 11.

In the filter processing (block A8 in FIG. 5, flowchart of FIG. 11), information about a content that cannot be reproduced by the player 1 is deleted from the content list 50.

When the filter processing is completed for all the content information parts 6₁, 6₂, . . . contained in the content list 50, information about a content that cannot be reproduced by the player 1 is removed and only content information parts of contents which can be reproduced by the player 1 remain.

The CPU 11 of the player 1 subjects the content list 50 to license confirmation processing (block A9). In the first embodiment, for all contents contained in the content list 50, acquisition is determined whether or not to the user. In the license confirmation processing of the present embodiment, determination is made not only as to whether a content is permitted to acquire, but also as to whether the permission has any term of validity and whether the term of validity has expired.

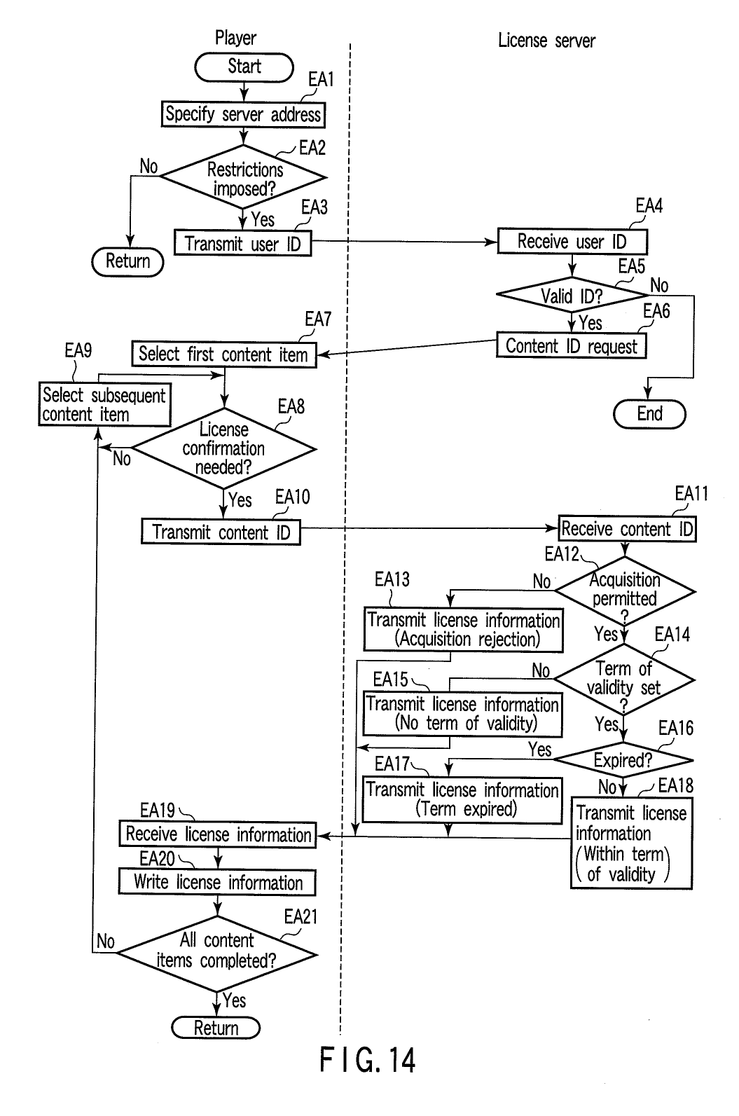

FIG. 14 is an exemplary flowchart showing license confirmation processing according to the second embodiment.

Firstly, the CPU 11 of the player 1 specifies the address of the license server 202 (block EA1). The address of the license server 202 is contained in the content list 50 transmitted from the selected content server 201. For example, in the content list 50 shown in FIG. 10, the address of the license server 202 is described in the server information 52. The CPU 11 detects the address of the license server 202 from the server information 52. If the address of the license server 202 is not contained in the content list 50, the address of the license server 202 may be inquired of the selected content server 201.

Next, the CPU 11 determines whether or not the content server 201 imposes restrictions on users (block EA2). Whether the content server 201 imposes restrictions on users or not can be determined based on information contained in the server information 52 of the content list 50.

When the content server 201 does not impose restrictions on users to acquire content a content (No in block EA2), the flow returns to the flowchart of FIG. 5.

On the other hand, when the content server 201 imposes restrictions on users to acquire content (Yes in block EA2), the CPU 11 of the player 1 reads user ID stored in the ROM 21 and transmits the read user ID to the specified address (block EA3). Alternatively, the user may be prompted to enter the user ID and the entered user ID may be transmitted to the specified address.

After receiving the user ID (block EA4), the license server 202 determines whether or not the received user ID is a valid user ID issued by the content server 201 (block EA5). When the received user ID is different from user IDs which the license server 202 manages, it is determined that the received user ID is not a valid user ID.

When it is determined that the received user ID is not a valid user ID (No in block EA5), the user of the player 1 is considered not licensed by the content server 201 and content list display processing terminates. Then, predetermined processing such as license confirmation processing with another license server will be performed.

On the other hand, when it is determined that the received user ID is a valid user ID (Yes in block EA5), the license server 202 requests the player 1 to transmit content ID of a content (block EA6).

The CPU 11 of the player 1 selects the first content information part 6₁ and the corresponding content as a processing target from the content information parts 6₁, 6₂, . . . contained in the content list 50 (block EA7).

The CPU 11 determines whether or not it is required to confirm the license of the content of the processing target. This determination is made based on information described in the selected content information part 6₁. There is no need to confirm license of a content which the content server 201 allows any user to acquire.

When it is determined that there is no need to confirm the license (No in block EA8), the CPU 11 selects subsequent content information part as a processing target from the content list 50 (block EA9) and the flow returns to block EA8 to determine whether or not license confirmation is required for the content newly selected as a processing target.

When it is determined that confirmation of the license is needed for the content of the processing target (Yes in block EA8), the CPU 11 transmits the content ID corresponding to the content of the processing target to the license server 202 from the wireless network unit 43 (block EA10).

After the content ID is received (block EA11), the license server 202 determines whether or not the user of the player 1 is permitted (licensed) to acquire the content of the processing target (block EA12). The license server 202 stores content IDs of contents allowed for the user to acquire in association with the user ID. The license server 202 makes a determination of block EA12 by means of checking data stored therein against the data transmitted from the player 1.

When it is determined that the user of the player 1 is not permitted to acquire the content of the processing target (No in block EA12), the license server 202 transmits to the player 1 license information (Acquisition rejection) indicating that the content is not permitted to acquire (block EA13).

On the other hand, when it is determined that the user of the player 1 is permitted to acquire the content of the processing target (Yes in block EA12), the license server 202 subsequently determines whether or not a term of validity, during which the user of the player 1 can acquire the content of the processing target, is set (block EA14). The license server 202 also manages information of the term of validity in association with the user ID and the content ID.

When no term of validity is set for the user of the player 1 to acquire the content of processing target (No in block EA14), the license server 202 transmits to the player 1 license information (No term of validity) indicating that no term of validity is set for acquiring the content (block EA15).

On the other hand, when a term of validity is set (Yes in block EA14), the license server 202 determines whether or not the term of validity has already expired (block EA16).

When the term of validity has expired (Yes in block EA16), the license server 202 transmits to the player 1 license information (Term expired) indicating that the term of validity for acquiring the content has already expired (block EA17). On the other hand, when the term of validity has not expired yet (No in block EA16), the license server 202 transmits to the player 1 license information (Within term of validity) indicating that the license to acquire the content is within the term of validity (block EA18).

The player 1 receives the license information transmitted from the license server 202 via the wireless network unit 43 (block EA19). The CPU 11 of the player 1 writes the received license information into the content information part of the processing target contained in the content list 50 (block EA20).

Then, the CPU 11 determines whether or not the license confirmation processing has been completed for all the content information parts 6₁, 6₂, . . . contained in the content list 50 (block EA21).

When there remains any content information part on which the license confirmation processing has not been executed (No in block EA21), the CPU 11 selects a subsequent content information part as a processing target from the content list 50 (block EA9) and repeats processing of block EA8 and thereafter.

When the license confirmation processing is completed for all the content information parts 6₁, 6₂, . . . , 6ₙ contained in the content list 50 (Yes in block EA21), the flow returns to processing of the flowchart in FIG. 5.

As a result of the license confirmation processing according to the above present embodiment, not only whether the user of the player 1 is permitted to acquire a content or not, but also information about a term of validity of acquiring the content is written in each of the content information parts 6₁, 6₂ . . . of the content list 50.

When the license confirmation processing is completed, a list of contents is displayed based on the content list 50 (block A10 in FIG. 5), and then the content list display processing terminates.

Here, the CPU 11 displays distinguishably a content which is not allowed to acquire, a content whose term of validity has expired, and a content within a term of validity, with reference to license information written in each of the content information parts 6₁, 6₂, . . . .

For example, a content which has a term of validity may be displayed with a mark indicating the term of validity, and a content whose term of validity has expired with a mark of warning. Accordingly, the user can also recognize information about terms in which the contents can be acquired.

The user can select one or more contents by operating the multifunction button 3a from the content list displayed on the LCD 5 by the content list display processing. When a content which is permitted to acquire (content which requires no license confirmation, content within the term of validity) is selected, the selected content is downloaded from the content server 201. When a content which is not permitted to acquire (content whose license has expired, unlicensed content) is selected, the player 1 does not download the selected content.

Also in the present embodiment, when a content is selected, the player 1 may transmit license information of the selected content to the content server 201. The content server 201 can perform processing based on the transmitted license information. In the present embodiment, license information obtained as a result of the license confirmation processing (block A9 in FIG. 5, flowchart of FIG. 14) contains information about the term of validity of content acquisition. For example, when the license information transmitted from the player 1 to the content server 201 indicates expiration of the term of validity, the content server 201 sends screen data for prompting the user to obtain the permission again. The player 1 proceeds to permission obtaining processing according to a link to the predetermined permission obtaining processing contained in the screen data. When the license information transmitted from the player 1 to the content server 201 indicates that the permission is within the term of validity of content acquisition, the content server 201 may transmit the selected content or screen data for extending the term of validity to the player 1.

According to the multimedia reproduction apparatus (player) 1 of the present embodiment, a list of contents which a content server distributes can be acquired from the content server. A content that cannot be reproduced by the player 1 can be deleted from the content list. Moreover, it can be inquired from a license server whether a content in the content list is allowed to acquire and inquiry can also be made as to information on a term of validity for acquiring the content. The response to the inquiries can be added to the content list.

Thus, when the content list is displayed, a content which is allowed to acquire and a content which is not allowed to acquire can be distinguished. In addition, a content whose term of validity has already expired and a content which is within the term of validity can be distinguished from each other. Further, processing to be executed when any content is selected from the content list can be changed depending on the term of validity for acquiring the selected content and depending on whether the selected content is allowed to acquire or not.

In the above description, the license server 202 manages the term of validity of content acquisition. In addition to this, the license server 202 can manage the number of times of valid reproduction of a downloaded content (the number indicating how many times the content can still be reproduced) and the like. In the license confirmation processing (block A9 in FIG. 5, flowchart of FIG. 14), information about the number of times of valid reproduction can be attached to the license information and transmitted to the player 1. The player 1 can attach to the content list and display the number of times of valid reproduction based on the received license information (block A10 in FIG. 5). Alternatively, the license server 202 may manage the number of contents a user can download in a given period from the content server 202. In the license confirmation processing (block A9 in FIG. 5, flowchart of FIG. 14), the number of contents the user can download from the content server 201 can be attached to the license information and transmitted to the player 1. The player 1 can attach to the content list and display the number of contents the user can thereafter download based on the received license information (block A10).

Therefore, the user can easily obtain more detailed license information of contents provided from the content server 201. Moreover, processing in accordance with items of license information acquired for respective contents can also be performed.

In the present embodiment, user ID issued by the content server 201 is stored in the ROM 21; however, the user ID may be stored in the HDD 7 in advance. Moreover, portal site addresses, menu screen data acquired from the content server 201, and update data thereof are stored in the ROM 21; however such data may also be stored in the HDD 7.

In the present embodiment, the player 1 acquires the latest link list by the menu update processing (block A4 in FIG. 5, flowchart of FIG. 8). Thus, even when an address of content server 201 has changed, the player 1 can easily access the content server 201 based on the latest menu screen data provided by the portal site 203.

Furthermore, in the present embodiment, the content list 50 is acquired from the content server 201 in block A7 in FIG. 5. Even a user who is not licensed by the content server 201 can also acquire the content list 50. When there is any content in the acquired content list 50 that interests a user, the user can try to obtain a license from the content server 201.

In the present embodiment, the content list 50 acquired from the content server 201 includes information such as an address of corresponding license server 202; however, information about the license server 202 may be provided in a different manner.

In the present embodiment, the content list 50 acquired from the content server 201 is described in the RSS or Atom format, but any other format that can describe information of contents distributed by the content server 201 may also be used.

In the filter processing of the present embodiment (block A8 in FIG. 5 and the flowchart in FIG. 11), profile data of a content which is not licensed to a user can be acquired by the user. However, order of the filter processing (block A8 in FIG. 5) and the license confirmation processing (block A9 in FIG. 5) may be interchanged. Then, merely first 1 KB data of a content to which license information of acquisition permission is attached by the license confirmation processing may be downloaded.

The authentication processing (block A3 in FIG. 5, flowchart in FIG. 7) of the present embodiment uses the model name and serial number of the player 1 as authentication data; however, other information may also be used as authentication data.

Skin File Change Processing

The present invention is not limited to the above embodiments and may be modified in various ways. For example, the menu update processing (block A4 in FIG. 5, flowchart in FIG. 8) of the first and second embodiments can be modified as described below.

Generally, GUI designs (screen design of the LCD 5, appearance of characters and buttons and the like) of the player 1 are defined by a given skin file. This skin file can be managed by the portal site 203. In the above menu update processing, the portal site 203 can transmit skin file change instructions to the player 1 together with the menu screen data.

The player 1 usually stores the skin file in the ROM 21.

In the menu update processing shown in FIG. 8, when starting the menu update processing is requested from the CPU 11 of the player 1 (block C1), the portal site 203 requests the player 1 to transmit update data of menu screen data which the player 1 stores (block C2). At the same time, the portal site 203 also requests the player 1 to transmit the model name of the player 1 and information on the skin file which the player 1 stores. However, if the model name has already been provided as authentication data in the authentication processing of block A3, the model name need not be transmitted.

In response to the request, the CPU 11 of the player 1 transmits the model name, skin file information, and the update data stored in the ROM 21 to the portal site 203 from the wireless network unit 43 (block C3).

The portal site 203 determines not only whether or not the player 1 needs to obtain the latest menu screen data, but also whether or not the skin file also needs to be changed (block C4).

FIG. 15 is an exemplary view showing data stored in a skin determination table 203a which the portal site 203 holds. The portal site 203 detects a skin file suitable for the player 1 based on the skin determination table 203a. In the example shown in FIG. 15, a skin file suitable for the player 1 is detected from a combination of whether the menu screen data has been updated (that is, whether the player 1 needs to obtain the latest menu screen data) and the model name of the player 1. Then, the portal site 203 determines whether the detected skin file is different from the skin file stored in the ROM 21 of the player 1 based on skin file information transmitted from the player 1 (block C4). When the skin files are different, the player 1 needs to change the skin file.

The portal site 203 notifies the player 1 whether the menu screen is required to be updated or not in block C5 or block C6, and whether the skin file is required to be changed is also notified.

Subsequently, the CPU 11 of the player 1 determines whether the latest menu screen data needs to be obtained and the skin file needs to be changed based on the notification from the portal site 203 (block C7).

When it is necessary to obtain the latest menu screen data or to change the skin file, the player 1 requests the portal site 203 to transmit required data (block C8). In response to the request from the player 1, the portal site 203 transmits the latest menu screen data or the skin file data to the player 1 (block C9).

Data transmitted from the portal site 203 is received via the wireless network unit 43 of the player 1 (step C10). The CPU 11 of the player 1 stores the received menu screen data or the skin file data in the ROM 21 (block C11). Then, the flow returns to the flowchart of FIG. 5.

In the subsequent block A5, the menu screen is displayed based on the skin file obtained in the above menu update processing. Therefore, the display of the LCD 5 can be made different between the case where the menu screen has been updated and the case where the menu screen has not been updated. This allows the user to visually recognize update of the menu screen easily.

In the above skin determination table 203a shown in FIG. 15, skin file data is stored in association with the model name of the player 1 and whether menu screen data is updated or not. However, the skin determination table 203a may also store, for example, skin file data depending on the season. Alternatively, the skin file suitable for the player 1 may be determined based on other elements.

Thus, the player 1 can be caused to make a display intended by the portal site 203.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one or more computers, such as servers. While the various modules are illustrated separately, they may share some or all of the same underlying logic or code.

What is claimed is:

1. An information processing apparatus comprising:
a communication module configured to communicate through a network with a content server configured to provide contents and a license server configured to manage license information of the contents provided by the content server;
an inquiry module configured to inquire of the license server permission to acquire a content provided by the content server via the communication module; and
a display module configured to display a list of the contents provided by the content server in accordance with a result of inquiry made by the inquiry module.

2. The information processing apparatus of claim 1, wherein the display module is configured to display the list of the contents provided by the content server so that a content permitted to acquire is distinguished from a content not permitted to acquire.

3. The information processing apparatus of claim 1, wherein the inquiry module is configured to inquire of the license server whether or not a term of acquisition is set to a content provided by the content server, and wherein the display module is configured to display the list of the contents so that a content to which the term of acquisition is set is distinguishable.

4. The information processing apparatus of claim 1, wherein the inquiry module is configured to inquire of the license server whether or not permission to acquire a content provided by the content server has expired, and the display module is configured to display the list of the contents so that a content of which permission to acquire has expired is distinguishable.

5. The information processing apparatus of claim 1, wherein the inquiry module is configured to inquire of the license server a number of contents permitted to acquire from the content server and the display module is configured to display the number of contents permitted to acquire.

6. The information processing apparatus of claim 1, further comprising a list acquisition module configured to acquire a list of the contents provided by the content server, and wherein the inquiry module is configured to inquire of the license server permission to acquire a content comprised in the list of the contents acquired by the list acquisition module.

7. The information processing apparatus of claim 6, wherein the list of the contents comprises information indicating whether or not it is appropriate for the inquiry module to inquire of the license server permission to acquire the contents respectively.

8. The information processing apparatus of claim 7, further comprising:
a reproduction module configured to reproduce a content;
a detection module configured to detect a content which the reproduction module is not allowed to reproduce; and
a deletion module configured to delete information of the content which the reproduction module is not allowed to reproduce detected by the detection module from the list of the contents.

9. The information processing apparatus of claim 1, wherein
the content server is configured to assign user identification data to a user permitted to acquire a content and to assign content identification data to a content to be provided, and
the license server is configured to manage the user identification data linked to content identification data of a content permitted for the user to acquire.

10. The information processing apparatus of claim 9, wherein
the inquiry module is configured to transmit user identification data and content identification data to the license server via the communication module and to inquire whether or not a user identified by the transmitted user identification data is permitted to acquire a content identified by the transmitted content identifying data, and
the license server is configured to check the transmitted user identification data and the transmitted content identification data against the user identification data and the content identification data managed by the license server, and to determine whether or not the user identified by the transmitted user identification data is permitted to acquire the content identified by the transmitted content identification data.

11. The information processing apparatus of claim 1, further comprising:
a list of links acquisition module configured to acquire via the connection module a list comprising links to content servers from a portal site connected to the network;
a list of links display module configured to cause the display module to display the list of links acquired by the list of links acquisition module; and
a selection module configured to select a content server from the content servers comprised in the list of links in accordance with selection made by a user, wherein the inquiry module is configured to inquire of the license server permission to acquire a content provided by the content server selected by the selection module.

12. The information processing apparatus of claim 11, wherein the list of links display module is configured to cause the display module to distinguishably display a content server configured to impose restrictions on provision of contents.

13. The information processing apparatus of claim 12, wherein the inquiry module is configured to inquire of the license server permission to acquire a content provided by the content server selected by the selection module when a content server which imposes restrictions on provision of contents is selected by the selection module.

14. The information processing apparatus of claim 11, further comprising a skin file acquisition module configured to acquire a skin file configured to define a display manner of the display module from the portal site via the communication module, and wherein the list of links display module is configured to cause the display module to display the list of links in accordance with the skin file acquired by the skin file acquisition module.

15. The information processing apparatus of claim 14, wherein the portal site comprises a management table for managing skin files.

16. A content list display method comprising:
inquiring permission to acquire a content provided by a content server configured to provide contents from a license server configured to manage license information of contents; and
displaying a list of the contents provided by the content server in accordance with a result of the inquiry.
